(19) United States
(12) Patent Application Publication
(10) Pub. No.: US 2004/0076108 A1
(43) Pub. Date: Apr. 22, 2004

(54) Interference isolation apparatus for a pick up head

(76) Inventor: Nomo Yang, Lujou City (TW)

Correspondence Address: RABIN & Berdo, PC, 1101 14TH STREET, NW, SUITE 500, WASHINGTON, DC, 20005, US

(21) Appl. No.: 10/682,524

(22) Filed: Oct. 10, 2003

(30) Foreign Application Priority Data
Oct. 14, 2002 (TW) 91216306

(51) Int. Cl. G11B 17/00; G11B 21/16

(52) U.S. Cl. 369/249

(57) ABSTRACT

An interference isolation apparatus for the pick up head, applied in an optically readable storage apparatus, wherein the optically readable storage apparatus includes a pick up head supported by two support shafts, a motor, and multiple fastening components. The interference isolation apparatus includes at least four insulating sheaths, respectively wrapping around each end of the two support shafts, for the purpose of isolating electric interference between the pick up head and the motor. The insulating sheaths are formed integrally as an interference isolation device not only for effectively isolating interference, but also for convenient fabrication.

This application claims the benefit of Taiwan application Serial No. 91216306, filed on Oct. 14, 2002.

### BACKGROUND OF THE INVENTION

1. Field of the Invention

The invention relates in general to an interference isolation apparatus for a pick up head, and more particularly to an electric interference isolation apparatus for a pick up head applied in an optically readable storage apparatus.

2. Description of the Related Art

In an optically readable storage apparatus, both of the pick up head and the grounding part of the motor touch the supporting device so that the interference from electrical signals the quality of the pick up head will be affected.

As shown in FIG. 1, a partial view of an optically readable storage apparatus is illustrated. The pick up head 102 is supported by the left support shaft 104a and the right support shaft 104b by using a link device. A spindle motor 106 for rotating the disk is positioned at one side of the optically readable storage apparatus, and a sled motor 108 for moving and positioning of the pick up head 102 is positioned at the other side of the optically readable storage apparatus.

In general, the grounding part of the pick up head 102, the spindle motor 106, and the sled motor 108 are in contact with the support device, such as the chassis 110 shown in FIG. 1. Moreover, there are many metallic components, such as screws and spring leaves, in the optically readable storage apparatus. Therefore, the electrical signals produced by the spindle motor 106 and the sled motor 108 are transmitted to the pick up head 102 via the support shafts 140a, 140b or other metallic components and interfere with the pick up head 102, thus decreasing the performance of the pick up head 102.

As shown in FIG. 2, a conventional isolation device is illustrated. The traditional isolation device includes two insulation pieces 314a and 314b, which are respectively positioned on the upper and lower surfaces of the support shaft 204, for preventing the transmission of electrical signals produced by the spindle motor 106 and the sled motor 108 to the pick up head 102. However, the operation for fabricating the isolation device is to press the isolation device into the corresponding components by hand after placing the insulation pieces 314a and 314b onto the support shaft 204, which is laborious and time-consuming.

In addition, adhering insulation pieces onto the spindle motor 106 is an alternative approach, however, by which only obstructs the signal interference between the spindle motor 106 and the pick up head 102 but fails to prevent the interference from the sled motor 108 to the pick up head 102.

### SUMMARY OF THE INVENTION

It is therefore an object of the invention to provide an interference isolation for the pick up head. Using the insulating sheath formed integrally shaft as the interference isolation device not only effectively isolates the interference from the motor to the pick up head, it also makes fabrication more convenient.

The invention achieves the above-identified objects by providing an interference isolation apparatus for the pick up head, which is applied in an optically readable storage apparatus. The optically readable storage apparatus includes a pick up head spanning the two support shafts, a motor, and multiple fastening components. The interference isolation device of the invention includes at least four insulating sheaths, respectively arranged on each end of the two support shafts, for isolating interference between the pick up head and the motor.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (prior art) is a partial view of the conventional optically readable storage apparatus;

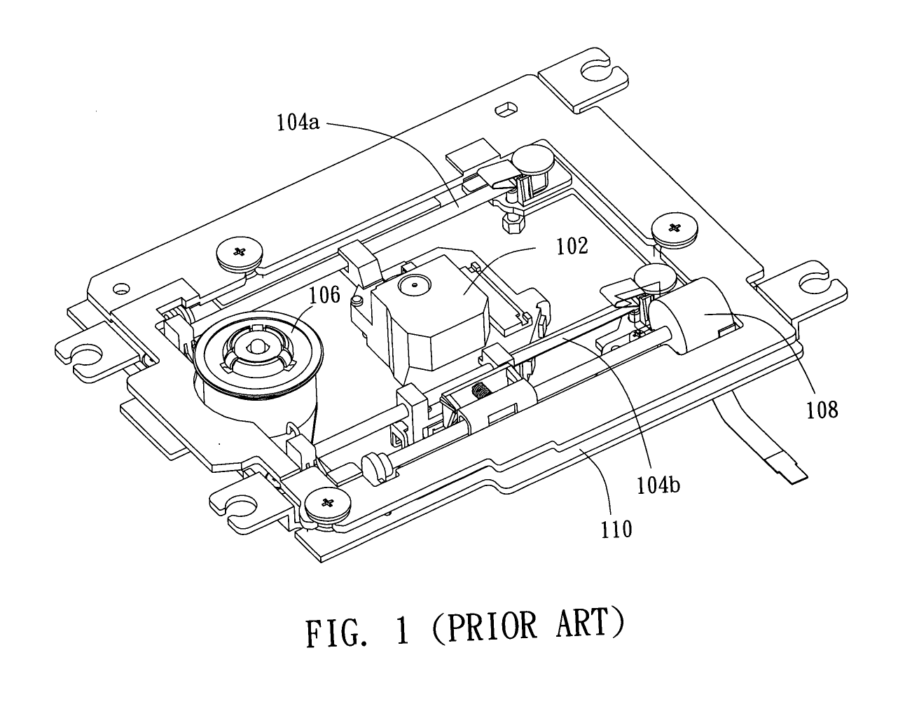

FIG. 2 (prior art) shows a conventional isolation device;

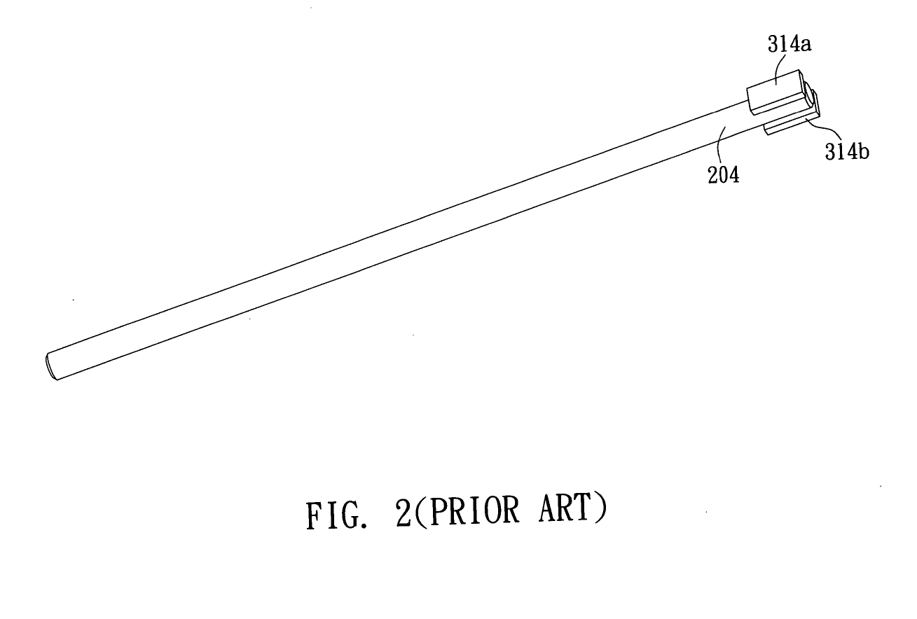

FIG. 3 is a partial view of an optically readable storage apparatus according to the preferred embodiment of the invention; and

FIG. 4 is an enlarged view of the insulating sheath and the support shaft of FIG. 3.

### DETAILED DESCRIPTION OF THE INVENTION

The invention devises an insulating sheath formed integrally with the support shaft, which not only effectively isolates interference between the motor and the pick up head but also provides for convenient fabrication.

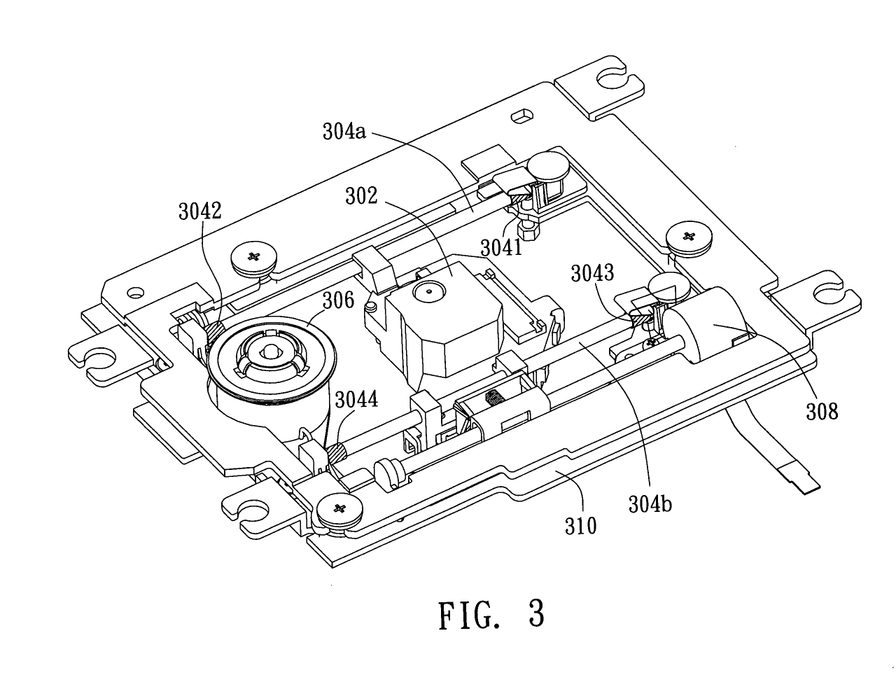

Referring to FIG. 3, a partial view of an optically readable storage apparatus according to the preferred embodiment of the invention is shown. The pick up head 302 lies in the center of the optically readable storage apparatus and supported by the left support shaft 304a and the right support shaft 304b by means of the link device. The spindle motor 306 for rotating the disk (not shown) and the sled motor 308 for moving and positioning of the pick up head are respectively set on both sides of the pick up head 302. The grounding part of the pick up head 302, the spindle motor 306, and the sled motor 308 contact the support device, such as the chassis 310.

Four insulating sheaths 3041, 3042, 3043 and 3044 are respectively disposed on each end of the left support shaft 304a and the right support shaft 304b, wherein the insulating sheath shall be made of insulating materials, preferably, durable, heat resistant insulating plastics. Notwithstanding many related metallic components are disposed in the optically readable storage apparatus, such as support shaft 304a, 304b, screws, and spring leaves, the electrical signals produced by the spindle motor 106 and the sled motor 108 are isolated and unable to be transmitted to the pick up head 302 due to the isolation of the four insulating sheaths 3041, 3042, 3043 and 3044.

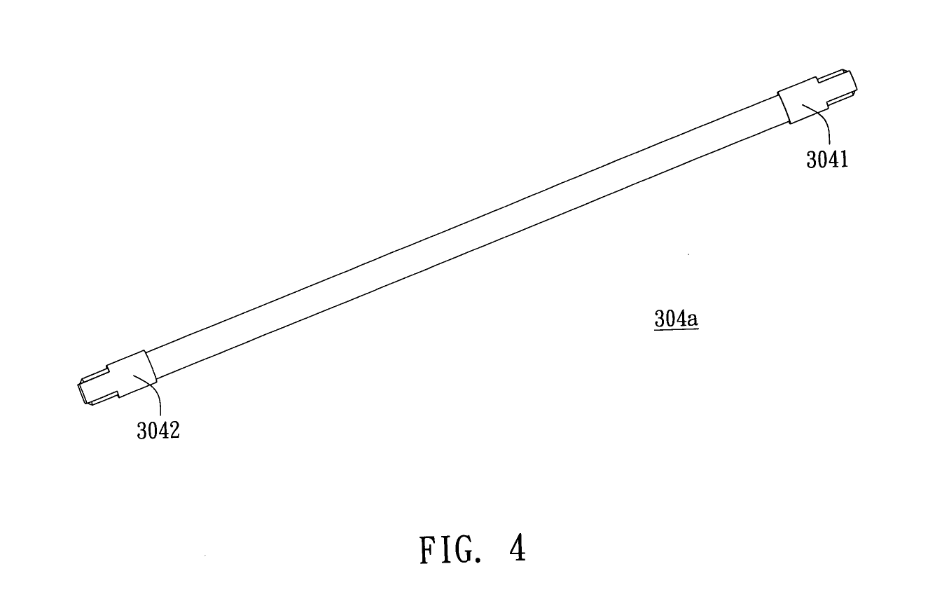

Referring to FIG. 4, an enlarged view of the insulating sheath and the support shaft of FIG. 3 is shown, using the insulating sheaths 3041, 3042 and the support shaft 304a as an example. The insulating sheaths 3041 and 3042 formed integrally shaft are respectively sheathed on each end of the support shaft 304a for the purpose of isolating interference. The design of the sheath is very convenient for fabricating, wherein the size of the insulating sheath matches that of the support shaft, thereby tightly wrapping around the support shaft.

In addition, considering the limitation of space for the movements of the pick up head 302 and other related components, the position of each insulating sheaths 3041, 3042, 3043 and 3044, is preferably arranged at each end of the support shafts 304a and 304b, as shown in FIG. 3.

Moreover, to obstruct every possible routes of the interference transmitted from the spindle motor 306 and the sled motor 308 to the pick up head 302, the number of insulating sheaths 3041, 3042, 3043 and 3044 is at least four.

The interference isolation apparatus for the pick up head according to the invention not only effectively isolates interference between the motor and the pick up head to maintain the quality of data storing and reading but also has advantages of convenient and effective fabrication.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An interference isolation apparatus for a pick up head, applied in an optically readable storage apparatus, wherein the optically readable storage apparatus comprises the pick up head supported by two support shafts, a motor, comprising:
at least four insulating sheaths respectively wrapping around each end of the two support shafts, for isolating the interference between the pick up head and the motor.

2. The interference isolation apparatus according to claim 1, wherein the insulating sheaths are formed integrally.

3. The interference isolation apparatus according to claim 1, wherein a size of the insulating sheath matches a size of the support shaft for tightly wrapping around the end of support shafts.

4. The interference isolation apparatus according to claim 1, wherein the motors comprises a spindle motor and a sled motor.

5. The interference isolation apparatus according to claim 1, wherein the optically readable storage apparatus further comprises a chassis for carrying a plurality of metallic components.

6. The interference isolation apparatus according to claim 5, wherein a grounding part of the spindle motor, the sled motor, and a grounding part of the pick up head are coupled to the chassis.
